(19) United States
(12) Patent Application Publication
(10) Pub. No.: US 2011/0163259 A1
(43) Pub. Date: Jul. 7, 2011

(54) HEAT TRANSFER FLUIDS AND HEAT STORAGE FLUIDS FOR EXTREMELY HIGH TEMPERATURES BASED ON POLYSULFIDES

(75) Inventor: Hans-Josef Sterzel, Dannstadt-Schauernheim (DE)

(73) Assignee: BASF SE, Ludwigshafen (DE)

(21) Appl. No.: 12/984,735

(22) Filed: Jan. 5, 2011

(30) Foreign Application Priority Data
Jan. 5, 2010 (DE) 102010004063.0

(51) Int. Cl. C09K 5/00

(52) U.S. Cl. 252/71

(57) ABSTRACT

A composition for the transport and storage of heat energy, which comprises alkali metal polysulfides of the formula (Me1₍₁₋ₓ₎,Me2ₓ)₂S_{z}, where Me1 and Me2 are selected from the group of alkali metals consisting of lithium, sodium, potassium, rubidium and cesium, Me1 is different from Me2 and x is from 0 to 1 and z is from 2.3 to 3.5.

Fluids for transferring heat energy are used in many fields of industry. In internal combustion engines, mixtures of water and ethylene glycol carry the waste heat of combustion to the radiator. Similar mixtures convey the heat from solar roof collectors to heat storages. In the chemical industry, they convey the heat from heating plants heated electrically or by means of fossil fuels to chemical reactors or from the latter to cooling apparatuses.

According to the requirements profile, many fluids are used. The fluids should be liquid at room temperature or even at lower temperatures and should, first and foremost, have low viscosities. Water is no longer possible for relatively high use temperatures; its vapor pressure becomes too high. For this reason, hydrocarbons which usually comprise aromatic and aliphatic parts of the molecule are used at temperature of up to 250° C. Oligomeric siloxanes are also frequently used for relatively high temperatures.

A new challenge to be met by heat transfer fluids is thermal solar power stations which generate electric energy on a large scale. Such power stations were hitherto built with an installed power of about 1000 megawatt in total. In one embodiment, the solar radiation is focused by means of parabolically shaped mirror grooves on to the focal line of the mirrors. There, there is a metal tube which is located within a glass tube in order to avoid heat losses, with the space between the concentric tubes being evacuated. A heat transfer fluid flows through the metal tube. According to the prior art, a mixture of diphenyl ether and biphenyl is usually used here. The heat transfer fluid is heated to a maximum of 380-400° C. and a steam generator in which water is vaporized is operated by means of this. This steam drives a turbine and this in turn drives the generator as in a conventional power station. Total efficiencies of about 20-23 percent, based on the energy content of the incident sunlight, are achieved in this way.

There are various possible ways of concentrating the solar radiation; apart from parabolic mirrors, Fresnel mirrors which likewise concentrate the radiation on a tube through which flow occurs are also employed.

Both components of the heat transfer fluid (diphenyl ether and biphenyl) boil at about 256° C. under atmospheric pressure. The melting point of biphenyl is 70° C., and that of diphenyl ether is 28° C. Mixing of the two substances lowers the melting point to about 10° C.

The mixture of the two components (diphenyl ether and biphenyl) can be used up to a maximum of 380-400° C.; at higher temperatures, decomposition occurs, hydrogen gas is evolved and insoluble condensation products deposit in pipes and vessels. The vapor pressure at these temperatures is about 10 bar, a pressure which is still tolerable in industry.

To obtain total efficiencies higher than 20-23 percent, higher steam entry temperatures are necessary. The efficiency of a steam turbine increases with the turbine inlet temperature. Modern fossil fuel-fired power stations work at steam entry temperatures of up to 650° C. and thereby achieve efficiencies of about 45%. It would be technically quite possible to heat the heat transfer fluid in the focal line of the mirrors to temperatures of about 650° C. and thus likewise achieve such high efficiencies; however, this is prohibited by the limited heat resistance of the heat transfer fluids.

There are obviously no organic substances which are able to withstand temperatures above 400° C. over the long term; at least, there are none known to date. For this reason, attempts have been made to use inorganic, more heat-resistant liquids instead. The possibility known from nuclear technology of using liquid sodium as heat transfer fluid has been intensively examined. However, the fact that sodium is fairly expensive, that it has to be produced with high energy consumption by electrolysis of sodium chloride and that it reacts with even traces of water to evolve hydrogen and thus represents a safety problem have stood in the way of practical use.

These problems are even more acute in the case of the eutectic alloy of sodium and potassium (about 68 atom percent of potassium) which crystallizes at −12° C.

Another possibility is the use of inorganic salt melts as heat transfer fluid. Such salt melts are prior art in processes which operate at high temperatures. Working temperatures of up to 500° C. and crystallization temperatures down to 100° C. are achieved using mixtures of potassium nitrate, sodium nitrate, the corresponding nitrates and optionally further cations such as lithium or calcium (U.S. Pat. No. 7,588,694).

The fertilizer industry is capable of producing large amounts of the nitrites and nitrates. However, two considerable disadvantages of the salt melts lead to them being used only tentatively in solar thermal power stations: as nitrates, they have a strongly oxidizing effect on metallic materials, preferably steels, at elevated temperatures, as a result of which their maximum use temperature is limited to the about 500° C. mentioned above. Secondly, the thermal stability of the nitrates is limited at elevated temperatures. They decompose with elimination of oxygen to form insoluble oxides. Owing to their crystalline melting point, the minimum use temperature is about 160° C. A further lowering of the melting point can be achieved by addition of lithium or calcium salts. However, the lithium salts result in greatly increased costs, and a proportion of calcium increases the melt viscosity at low temperatures in a disadvantageous way.

At present, salt melts are used as heat storage fluid in solar thermal power stations. However, biphenyl and diphenyl ether mixtures continue to be mostly used in the solar field, as a result of which the storage temperature continues to be limited to about 390° C.

Whether water under an appropriately high pressure is suitable as heat transfer fluid has likewise been examined. However, the extremely high vapor pressure of more than 300 bar stands in the way of this, since such a high vapor pressure would make the thousands of kilometers of pipes in a large thermal solar power station uneconomically expensive. Steam itself is unsuitable as heat transfer fluid and heat storage fluid because of its comparatively low thermal conductivity and the low heat capacity per unit volume compared to a liquid.

A further problem arises because it is desirable also to operate a solar thermal power station at night. For this purpose, considerable quantities of heat transfer fluid have to be stored in large, thermally insulated tanks.

If the heat content is to be stored for from thirteen to fourteen hours for a power station having an electric output of about one gigawatt, this requires tank contents of the order of a hundred thousand cubic meters at 600° C. and an efficiency of 40% from the heat reservoir to the outlet of the generator. This means that the heat transfer fluid has to be very inexpensive since otherwise the capital cost for such a power station becomes uneconomically high. It also means that sufficient material of the heat transfer fluid has to be available, since hundreds of one gigawatt units are required for supply on a large scale and to secure the base load.

The solution to the economical supply of solar energy on a large scale therefore ultimately depends on whether there is a heat transfer fluid which can be used in the long term at temperatures of up to 650° C., has a very low, economically manageable vapor pressure, preferably below 10 bar, at this temperature, does not oxidatively attack the iron materials used and has a very low melting point.

At first glance, these conditions could most easily be satisfied by elemental sulfur. Sulfur is available in sufficiently large quantities; there are very large, high-yielding deposits and sulfur is obtained as waste in the desulfurization of fuels and natural gas. At present, there are no possible uses for millions of metric tons of sulfur.

The melting point of sulfur of just about 120° C. is lower than that of salt melts for use as heat transfer fluid and the boiling point of sulfur of 444° C. is in the correct range: decomposition is virtually ruled out. At 650° C., the vapor pressure of sulfur is about 10 bar, a pressure which is industrially manageable. At 120° C., the viscosity of sulfur is only about 7 centipoise (7 mPas).

The density of liquid sulfur is on average about 1.6 kg/liter over a wide temperature range, the specific heat is about 1000 joule per kg and degree or about 1600 joule per liter and degree. It is thus below that of water, viz. 4000 joule per liter and degree, but above the specific heat of most customary organic heat transfer fluids. (Materials data; Hans Günther Hirschberg, Handbuch Verfahrenstechnik and Anlagenbau, page 166, Springer Verlag 1999, ISBN 3540606238).

A disadvantage of elemental sulfur for use as heat transfer fluid or a storage fluid could be its viscosity behavior:

In the temperature range from about 160 to 230° C., the cyclic sulfur molecules undergo ring-opening polymerization to form very long chains. While the viscosity above the melting range is about 7 mPas, it increases at 160° C. to 23 mPas and at temperatures in the range from 170 to 200° C. it reaches maximum values of about 100 000 mPas. The polymerization of sulfur thus generally brings about an increase in viscosity, so that the normal purified sulfur can in general no longer be pumped in this temperature range, which is not very suitable for use as heat transfer fluid.

It was an object of the invention to discover a composition for the transport and storage of heat energy (hereinafter also referred to as “heat transfer medium/heat storage medium of the invention”), which comprises sulfur and does not display the disadvantages indicated above, for example the relatively high vapor pressure at elevated temperatures and especially the viscosity increase.

As a result of the developments of the sodium-sulfur battery, some industrially important properties of polysulfide melts, as described below, have become known in the past.

Melting point minima occur in the binary systems at the compositions Na₂S₃ at 235° C. and K₂S_{1.44} at 112° C.; Na₂S₃ does not exist in the melt but instead a mixture of predominantly Na₂S₂ and Na₂S₄ is present. The lowest eutectic melting point in the (calculated) ternary system K—Na—S is displayed by a polysulfide of the composition (K_{0.77}Na_{0.23})₂S_{3.74} at 73° C. (Lindberg, D., Backman, R., Hupa, M., Chartrand, P., “Thermodynamic evolution and optimization of the Na—K—S— system” in J. Chem. Thenn. (2006) 38, 900-915).

Some references state that sodium polysulfides are unstable at their melting points. The potassium polysulfides are said to be more stable. According to these references, K₂S₄ decomposes under atmospheric pressure at 620° C. into K₂S₃ and sulfur; K₂S₃ decomposes at 780° C. into K₂S₂ and sulfur (U.S. Pat. No. 4,210,526).

The ranges having molar sulfur species from S₂ to S₃ are thus particularly stable. If the phase diagrams of the binary systems are examined, a melting point of, for example, 360° C. is found for Na₂S_{2.8}, a melting point of 250° C. is found for K₂S_{2.8} and a melting point of about 270° C. is found for the ternary polysulfide NaKS_{2.8}.

The quite high melting points do not provide much encouragement to look at alkali metal polysulfides for use as heat transfer medium and heat storage medium.

Rather, the viscosity behavior of the polysulfides points away from concentrating on this class of compound: on closer examination of the melts of alkali metal polysulfides it has been found that the alkali metal polysulfides have increased viscosities at temperatures below 200° C. Thus, sodium polysulfides of the formula Na₂S_{3.4} have a viscosity of about 10 centipoise at 400° C. (“The Sodium Sulfur Battery”, J. L. Sudworth and A. R. Tilley, Univ. Press 1985, pages 143-146, ISBN 0412-16490-6).

This value doubles on lowering the temperature by 50° C., i.e. to 20 cP at 350° C., 40 cP at 300° C., 160 cP at 200° C., 320 cP at 150° C. and, extrapolated further, 640 cP if the polysulfide was still liquid at 100° C. The latter value of 640 cP corresponds to about half the viscosity of glycerol at room temperature (1480 cP). For comparison, the viscosity of water is about 1 cP, that of olive oil from about 100 to 200 cP. The alkali metal polysulfides often solidify in a vitreous fashion and form high-viscosity glasses which slowly crystallize over a period of days at room temperature.

Finally, the corrosion behavior of the alkali metal polysulfide melts likewise provides no encouragement to examine this class of compounds for use as heat transfer fluid and heat storage fluid. Thus, it is known, for example, that alkali metal polysulfide melts can rapidly dissolve even metallic gold to form complex sulfides.

In the following, “Me” represents the group of the following alkali metals of the Periodic Table of the Elements: lithium, sodium, potassium, rubidium and cesium.

It has now surprisingly been found that alkali metal polysulfides of the composition (I) (hereinafter also referred to as “alkali metal polysulfides according to the invention”)

(Me1₍₁₋ₓ₎Me2ₓ)₂Sₓ (I)

where Me1 and Me2 are selected from the group of alkali metals consisting of lithium, sodium, potassium, rubidium and cesium, Me1 is different from Me2 and x is from 0 to 1 and z is from 2.3 to 3.5, are still fluid at temperatures down to 130° C., i.e. have significantly lower melting points and viscosities than those to be expected from the literature.

Preference is given to the polysulfides defined above in formula (I) in which Me1=potassium and Me2=sodium, particularly preferably the polysulfides defined above in formula (I) in which x is from 0.5 to 0.7 and z is from 2.4 to 2.9. with particular preference being given to the polysulfides defined above in formula (I) in which Me1=potassium and Me2=sodium and x is from 0.5 to 0.7 and z is from 2.4 to 2.9.

Further particular preference is given to the polysulfides of the formulae (Na_{0.5-0.65}K_{0.5-0.35})²S_{2.4-2.8} or (Na_{0.6}K_{0.4})₂S_{2.6}

The melting points observed were generally more than 200° C. lower than the literature values.

According to the present state of knowledge, these are attributable to the different method of synthesis of the alkali metal polysulfides according to the invention compared to the literature.

The alkali metal polysulfides according to the invention can be obtained by the following processes.

For the purposes of the invention, very economical synthetic routes should be employed. For this purpose, concentrated aqueous solutions of the corresponding alkali metal hydrogensulfides (MeHS). for example sodium hydrogensulfide, NaHS, or potassium hydrogensulfide, KHS, which are obtained by passing hydrogen sulfide into the aqueous hydroxide solutions of the corresponding alkali metals Me, were reacted with sulfur according to the general formula

2MeHS+zS - - - >Me₂S_{(z+1)}+H₂S (Me=alkali metal, for example K, Na)

with one equivalent of hydrogen sulfide being given off. This hydrogen sulfide can be recirculated and reused for preparing the alkali metal hydrogen sulfides.

The water of reaction and the solution water were preferably distilled off quickly with the temperature being increased to up to 500° C. to give the alkali metal polysulfides according to the invention.

In science, on the other hand, attempts are made to prepare polysulfides which are as pure as possible; the economics generally plays no role. For this reason, the alkali metals are reacted with elemental sulfur, usually in liquid ammonia by means of which the considerable heat of reaction evolved in this reaction is removed, in order to prepare the pure polysulfides.

According to the present state of knowledge, the different properties of the alkali metal polysulfides according to the invention are due to the different synthetic routes:

Very pure alkali metal polysulfides are obtained by the water-free synthesis according to the prior art.

In the synthesis according to the invention, water and hydrogen sulfide are generally present. Water and hydrogen sulfide participate, according to the present state of knowledge, in the reaction in very complex, temperature-dependent equilibria and presumably result in other structures and/or other molar mass distributions than in the water-free synthesis. Very small residues of water and/or hydrogen sulfide, hydrogensulfides or sulfane end groups which are firmly bound and impossible to remove under the economical process conditions according to the invention may possibly also be responsible for lowering melting point and viscosity of the alkali metal polysulfides according to the invention.

This observation leads to the solution to the melting point and viscosity problems:

A further process for preparing the alkali metal polysulfides of the formula (I) according to the invention or the above-described preferred embodiments thereof is the reaction of alkali metal hydrogensulfides with sulfur in concentrated aqueous solution to form the alkali metal polysulfides according to the invention and, preferably, the subsequent substantial dewatering thereof by directly distilling off the water.

It is also possible to prepare the alkali metal polysulfides according to the invention by reacting the alkali metal hydrogensulfides with alkali metal hydroxide to form the alkali metal sulfides according to

MeHS+MeOH<- - - >Me₂S+H₂O

and reacting the alkali metal sulfides with further sulfur to form the polysulfides.

However, there is a risk in this synthesis that a high concentration of hydroxide ions will be present in the concentrated aqueous solution as a result of the hydrolytic backreaction; these can react in an undesirable secondary reaction with the sulfur of the subsequent reaction step to form high-melting and thermally unstable alkali metal thiosulfate.

6MeOH+zS - - - >2Me₂S_{(z-2})+Me₂S₂O₃+3H₂O

Alkali metal thiosulfates generally increase the melting point, increase the melt viscosity of the alkali metal polysulfides and decompose at elevated temperatures by various reaction routes to form further salts.

Decomposition products of the thiosulfates include the sulfates of the alkali metals which generally likewise have the disadvantageous properties of high melting point and viscosity as components in the polysulfide melt.

The synthetic route according to the invention avoids this secondary reaction; there are usually no excess hydroxide ions in an elevated concentration.

In a further variant for preparing the alkali metal polysulfides according to the invention, it is possible to avoid the secondary reactions and thus likewise avoid excess hydroxide ions by working with a substoichiometric amount of alkali metal hydroxide in the reaction of alkali metal hydrogensulfide with alkali metal hydroxide. In this case, a maximum of 0.9 mol of alkali metal hydroxide is used per mole of alkali metal hydrogensulfide. Corresponding to the substoichiometric molar amount of alkali metal hydroxide, a mixture of sulfide and hydrogensulfide is then usually present and is reacted with sulfur to form the alkali metal polysulfides according to the invention.

In a further variant for preparing the alkali metal polysulfides according to the invention, it is possible, instead of reacting the concentrated aqueous solutions of the alkali metal hydrogensulfides and optionally the sulfides in a mixture with hydrogensulfides with sulfur and dewatering the polysulfides, firstly to dewater the alkali metal hydrogensulfides, optionally in the mixture with sulfides, before reaction with the sulfUr and react the dewatered hydrogensulfides and any sulfides present therein with the sulfur in a second step.

This variant generally results in the high-melting dry substances being obtained in the dewatering of the hydrogensulfides or the sulfides present in admixture with the hydrogensulfides, which makes the preparation somewhat more complicated.

However, these process variants give alkali metal polysulfides according to the invention whose solidification temperature is about 10-20° C. below that of alkali metal polysulfides according to the invention having the same composition obtained by the first and preferred process variant.

Preference is given to using the alkali metal polysulfides according to the invention having z=2.3-3.5. Contrary to what is indicated in the literature, the pure alkali metal polysulfides, preferably sodium polysulfides, according to the invention having these sulfur contents prove to be extremely thermally stable up to about 700° C.

The high thermal stability of the alkali metal polysulfides, preferably sodium sulfides, according to the invention is particularly apparent at values of z of less than 3. Sulfur contents with values of z greater than 3.5 generally give disadvantageously increased viscosities.

The densities of the alkali metal polysulfides according to the invention at 350° C. are generally in the range from 1.8 to 1.9 g/cm³.

Of course, the use of cesium or rubidium as alkali metal is also suitable for the alkali metal polysulfides according to the invention. These alkali metals usually form polysulfides up to the hexasulfides.

According to the present hypotheses, the size of the ions influences the viscosity of the alkali metal polysulfides according to the invention. Thus, the larger potassium ions generally give somewhat lower viscosities than the smaller sodium ions.

Addition of further salts, for example alkali metal thiocyanates, to the alkali metal polysulfides according to the invention in order to reduce their melting points is preferably avoided. The thermal stability or the corrosion behavior (particularly at high temperature) of the alkali metal polysulfides according to the invention can be altered in a disadvantageous way as a result.

The heat transfer medium/heat storage medium of the invention usually comprise the alkali metal polysulfides according to the invention in a substantial amount up to a maximum of virtually 100% by weight, for example in the range from 20% by weight to virtually 100% by weight or from 50% by weight to virtually 100% by weight.

The heat transfer medium/heat storage medium of the invention are usually protected against intrusion of moisture during production, storage, transport and use. In general, the heat transfer medium/heat storage medium of the invention are therefore used in a closed system of pipes, pumps, regulating devices and vessels.

The low viscosity of the heat transfer medium/heat storage medium of the invention is particularly advantageous because a low viscosity promotes heat transmission and the energy required for pumping the liquid through the pipes is reduced. This can in many cases be more important than a broadening of the temperature range in a downward direction.

The negligibly low vapor pressure of the heat transfer medium/heat storage medium of the invention contributes by means of reduced wall thicknesses of pipes and apparatuses to lower capital costs and avoids sealing problems.

The operation of plants, preferably plants for energy generation, at temperatures up to 700° C. using the heat transfer medium/heat storage medium of the invention generally requires materials which are stable to sulfiding at high temperatures. As mentioned at the beginning, it is known from the literature that sodium polysulfide melts are able to dissolve metallic gold in the form of complex sulfides.

It has been found that the heat transfer medium/heat storage medium of the invention do not have a particularly great corrosion potential when they comprise very little volatile water which is capable of being distilled off.

Well-suited materials for the heat transfer medium/heat storage medium of the invention, particularly at elevated temperature, are the following:

Particularly corrosion-resistant materials are aluminum and in particular aluminum-comprising alloys, for example highly heat-resistant aluminum-comprising steels.

Such iron materials have ferritic microstructures and are free of nickel. Nickel sulfides form low-melting phases with iron. The most effective alloying constituent is aluminum, which forms an impermeable, passivating oxide layer and/or sulfide layer on the surface of the material. A relatively old material of this type having 22% by weight of chromium and 6% by weight of aluminum, a material which is used as heat conductor, has become known under the name Kanthal.

Iron alloys which are more resistant to sulfiding comprise less chromium and more aluminum, as described, for example, in EP 0 652 297 A. There, alloys having the composition: from 12 to 18 atom % of aluminum, from 0.1 to 10 atom % of chromium, from 0.1 to 2 atom % of niobium, from 0.1 to 2 atom % of silicon, from 0.01 to 2 atom % of titanium and from 0.1 to 5 atom % of boron are described. Niobium, boron and titanium serve to allow a fine-grained iron aluminide (Fe₃Al) to precipitate, as a result of which an increased toughness with elongations above 3% and improved processability are obtained.

A particularly good combination of resistance to sulfiding with good processability by casting, hot forming, cold forming and good ductility at room temperature with elongations at break of about 20% is given by an alloy composition comprising from 8 to 10% by weight of aluminum, from 0.5 to 2% by weight of molybdenum, balance iron. Silicon should not be present in the alloy since it decreases the ductility at room temperature. Proportions of chromium are likewise not advantageous; chromium sulfide is dissolved in the melts. Alloying-in of in each case up to 2% by weight of yttrium and/or zirconium also results in formation of zirconium oxide and/or yttrium oxide in the protective aluminum oxide layer, greatly increasing the ductility of the aluminum oxide and thus making the protective layer particularly stable against spelling and mechanical stresses in the event of temperature fluctuations. Zirconium oxide in particular increases the ductility of the aluminum oxide layer in an advantageous way.

The increased ductility of the base material and the protective oxide layer gives resistances to sulfiding which are comparable to those of alloys having higher aluminum contents. No microcracks are formed in the event of temperature changes and the alloys are not sensitive to hydrogen.

Iron alloys having still higher aluminum contents should be even more stable to polysulfide melts, but they can no longer be worked cold. They are extruded or rolled at elevated temperatures. Such alloys, which are alloys comprising Fe₃Al phases, comprise 21 atom % of aluminum, 2 atom % of chromium and 0.5 atom % of niobium or 26 atom % of aluminum, 4 atom % of titanium and 2 atom % of vanadium or 26 atom % of aluminum and 4 atom % of niobium or 28 atom % of aluminum, 5 atom % of chromium, 0.5 atom % of niobium and 0.2 atom % of carbon (EP 0455 752 A). The chromium content should be kept as low as possible; it is best to dispense with chromium as alloying element.

A very high molybdenum content, in so far as it does not reduce the room temperature ductility, should also suppress sulfiding. Molybdenum is recommended in addition to aluminum as housing material for sodium-sulfur batteries.

According to the literature, the corrosivity of alkali metal polysulfides decreases with decreasing sulfur content.

The mechanical strength of iron alloys having a high aluminum content is sufficiently high at temperatures of up to 700° C. for use with the heat transfer medium/heat storage medium of the invention.

The heat transfer medium/heat storage medium of the invention can be produced inexpensively from cheap intermediates by the conventional large-scale processes of the chemical industry.

The alkali metal polysulfides according to the invention can, for example, be prepared in the case of sodium or potassium by preparing the corresponding hydroxides from sodium chloride and potassium chloride by chloroalkali electrolysis.

The hydrogen formed at the same time is advantageously reacted with liquid sulfur to form hydrogen sulfide. In addition, the chemical industry has developed very elegant economical processes which operate continuously and at atmospheric pressure, as a result of which the storage of a large amount of hydrogen sulfide is superfluous (e.g. WO 2008/087086). It is produced in the mass flow which is just required by the next stage.

Of course, it is also possible to utilize the. hydrogen sulfide formed in desulfurization plants in the hydrogenation stages.

The hydrogen sulfide is generally reacted with the alkali metal hydroxides to form the alkali metal hydrogensulfides and these are subsequently reacted with sulfur to form the polysulfides.

It is also possible to prepare the alkali metal polysulfides according to the invention by reacting concentrated aqueous solutions of ammonium sulfide (NH₄)₂S or ammonium hydrogensulfide NH₄HS or mixtures of ammonium sulfide and ammonium hydrogensulfide with the corresponding alkali metal hydroxides with elimination of ammonia to give the corresponding alkali metal hydrogensulfides. Ammonia is recirculated to the synthesis of the ammonium sulfides.

In general, this synthetic route can be carried out when ammonium sulfide and/or ammonium hydrogensulfide are available inexpensively from another process, for example from the scrubbing of hydrogen sulfide from gases.

If the coproduction of chlorine by chloroalkali electrolysis is to be avoided, it is possible to convert low-chloride potassium sulfate or sodium sulfate having chloride contents of less than 0.01% by weight into the sulfides by means of reducing agents.

Potassium sulfate in particular is produced by the fertilizer industry In amounts of millions of metric tons per year. Economical processes for reducing the chloride content of potassium sulfate, e.g. by treatment of the salts with water, are known (DE 2 219 704). If hydrogen is used as reducing agent, it is possible to work at temperatures of from 600 to 700° C. in the solid state in a rotary tube furnace and obtain very clean sulfides (U.S. Pat. No. 20,690,958, DE 590 660). As catalysts for the reduction, use is generally made of from 1 to 5% by weight of alkali metal carboxylates. for example the formates or the oxalates.

However, the most effective catalysts appear to be alkali metal polysulfides which have to be mixed into the alkali metal sulfate only at the beginning of the reduction.

It is also possible to bring about the reduction of the alkali metal sulfates Me₂S0₄directly by means of natural gas according to the following equation:

Me₂S0₄+4/3CH₄ - - - >Me₂S+4/3CO+8/3H₂O

The sulfides are advantageously dissolved in water and converted into the hydrogensulfides by introduction of hydrogen sulfide gas: in concentrated aqueous solution, the equilibrium

Me₂S+H₂O<- - - >MeHS+MeOH

is established.

When hydrogen sulfide gas is introduced, this reacts with the hydroxide and the sulfide is converted into hydrogensulfide according to

H₂S+MeOH - - - >MeHS+H₂O

This gives the overall reaction:

Me₂S+H₂S - - - >2MeHS

This synthesis accordingly requires natural gas to produce the hydrogen, for example in the steam reforming process, and only inexpensive mineral raw materials as energy carriers and also the very inexpensive sulfur.

In this type of process, hydrogen sulfide is circulated and thus required in only small amounts, so that a separate process step for producing hydrogen sulfide is generally superfluous.

Me₂S+H₂S - - - >2MeHS

2MeHS+zS - - - >Me₂S_{(z+1)}+H₂S

Me₂S+zS - - - >Me²S_{(z+1)}

Here too, complete conversion of the sulfides into the hydrogensulfides is generally not necessary. It is usually sufficient for the formation of the alkali metal hydroxides to be suppressed by addition of hydrogen sulfide and a mixture of alkali metal sulfides and alkali metal hydrogensulfides having a very low concentration of alkali metal hydroxide to be present in order to achieve conversion into the alkali metal polysulfides according to the invention.

An advantage of the alkali metal polysulfides according to the invention is that they can be prepared in an inexpensive continuous process: the individual reaction steps proceed very quickly and exothermally. The reactants can therefore flow quickly through small reaction volumes.

A well-suited process is carried out as follows.

Hydrogen sulfide is passed with intensive cooling into concentrated aqueous solutions of the alkali metal hydroxides or alkali metal sulfides having a concentration of from 40 to 60% by weight. The reaction temperature is kept below 80° C. Subsequently, optionally after a step of concentrating the reaction solution to values of from about 50 to 80% by weight by rapid distillation, the concentrated alkali metal hydrogensulfide solution is reacted with the prescribed amount of liquid sulfur. Here, the heat of reaction evolved can be used to vaporize water. The water comprised in the reaction mixture is subsequently vaporized quickly with an increase in temperature up to 450° C., optionally with use of reduced pressure. The stream of hydrogen sulfide formed, mixed with water vapor, is cooled and the hydrogen sulfide is recirculated together with the hydrogen sulfide-comprising water to the stage of the hydrogensulfide synthesis. In general, no by-products which have to be disposed of occur.

All reaction steps are carried out under inert conditions. Oxygen is generally excluded because it can oxidize the polysulfides to undesirable thiosulfates which increase the melting point of the liquid and are usually unstable, sulfites and high-melting sulfates.

As reaction apparatuses, use is advantageously made of reaction mixing pumps followed by residence sections in order to complete the reactions. The reaction times of the individual reactions are in the range from 0.1 to 10 minutes. As apparatuses for removing the water, apparatuses such as falling film evaporators or thin film evaporators are generally used.

The heat transfer medium/heat storage medium of the invention generally make it possible to operate solar thermal power stations with the efficiencies of fossil fuel-fired power stations, advantageously allowing them to be operated day and night without interruption by means of appropriately dimensioned storage tanks for the hot liquid. Owing to the increased efficiency, the capital costs per kilowatt hour are generally reduced by a factor of 1.5 compared to the prior art.

The solidification point above room temperature can be countered structurally with little outlay by erecting the mirrors and the absorber tubes with a slight fall and draining the heat transfer medium/heat storage medium of the invention from the pipes into a collection tube shortly before sundown and storing them in thermally insulated buffer tanks in the liquid state at a few degrees above the solidification point for operation on the next day.

However, the heat transfer medium/heat storage medium of the invention can also be drawn off by suction into the thermally insulated tanks without a significant structural fall. When care is taken in the construction of the plants to ensure that no moveable apparatuses such as pumps or valves are present in the plant parts which become cold, residues of the heat transfer medium/heat storage medium of the invention can also freeze without disadvantages in these parts and be remelted later.

It is advantageous to keep moving parts such as pumps or regulating valves above the melting point of sulfur by additional heating. However, it is simplest to pump the heat transfer medium/heat storage medium of the invention slowly through the solar field after sundown and thus allow their temperature to drop to 150-200° C. The pipes generally have to be very well insulated thermally against heat losses so that the losses by thermal conduction are low, significantly lower than during daytime operation. At the comparatively low temperatures, the radiation losses through the absorber tubes located in a vacuum are likewise generally quite low. Should the temperature of the circulating heat transfer medium/heat storage medium of the invention drop too far, small amounts of the hot heat transfer medium/heat storage medium of the invention from the appropriate stock tank are mixed into these. The heat transfer medium/heat storage medium of the invention are advantageously used as heat transfer fluids in combination with absorber tubes which bear a coating which allows a high absorption capability for solar radiation combined with a low emission of heat radiation in the temperature range from 150 to 250° C.

The heat transfer medium/heat storage medium of the invention also makes combination with another heat transfer fluid possible. Thus, for example, the heat storage(s) of a solar thermal power station with its small amounts of storage medium can be operated using a very inexpensive sulfane-comprising and thus low-viscosity sulfur under superatmospheric pressure as storage medium while on the other hand operating the solar field with its absorber tubes under atmospheric pressure using the smaller amounts of the higher-priced alkali metal polysulfides according to the invention. The energy is in this case transferred via an intermediate heat exchanger.

The heat transfer medium/heat storage medium of the invention are just as suitable for a further type of construction of solar thermal power stations viz. the tower technology. as for the parabolic groove construction.

Subsequent mirrors guide the solar radiation to the top of a tower where it impinges on the receiver and heats the heat transfer fluid in the receiver to high temperatures. The heated liquid is utilized to generate steam and, fcir the purposes of storage, conveyed to a large-volume tank for night operation. At sundown, the liquid is simply allowed to run downward from the receiver into a storage tank. Even when water is vaporized directly in the receiver and a thermal engine is operated this way. there remains the problem of operating the plant at night. For this reason, a heat storage fluid is generally also indispensible for such types of power station.

However, the heat transfer medium/heat storage medium of the invention can also be used for all other uses in the fields of heat transport and heat storage in industry which require an extremely broad temperature range of the liquid phase and high temperatures. The vapor pressure of the medium is negligibly small for industrial purposes.

The heat transfer medium/heat storage medium of the invention are also particularly suitable for the transport of heat energy from the fuel elements of a nuclear reactor in a primary circuit which can be operated at virtually atmospheric pressure and thus safely up to temperatures of 700° C. This would make a safe, radiation-resistant heat transfer medium available. The steam temperatures in the secondary circuit can be increased considerably and the efficiency of nuclear power stations can thus be increased correspondingly.

The maximum temperatures at which the heat transfer medium/heat storage medium of the invention can be used is limited only by the stability of the materials of construction used.

In the event of loss of containment of product due to an accident, the heat transfer medium/heat storage medium of the invention are far less of a safety hazard or hazard to the environment than organic liquids.

If there is a loss of containment of a small amount of heat transfer medium/heat storage medium according to the invention, this is generally oxidized by atmospheric oxygen to form mineral sulfates within a few days. At elevated temperatures, the polysulfides can ignite in moist air because the ignition temperature of the hydrogen sulfide formed by hydrolysis is 270° C.

The polysulfides burn with a flame which gives off little light to form sulfur dioxide. Apart from sulfur dioxide, no environmentally toxic products are formed. Sulfur dioxide and the sulfur trioxide formed therefrom by oxidation by atmospheric oxygen are not known as greenhouse gases.

Burning alkali metal polysulfides can easily be extinguished by means of water because their density is greater than that of water. The vaporizing water quickly cools the polysulfide melt and the steam formed at the same time binds sulfur dioxide.

Sulfur dioxide can be absorbed by means of water, and the polysulfides readily dissolved in water.

Polysulfide residues adhering to plant components can easily be washed off completely with water without leaving any encrustations.

Polysulfides dissolved in water are likewise oxidized by atmospheric oxygen, usually forming sulfur and sulfates. Both the polysulfides and sulfur can be oxidized to sulfates in the soil by sulfur bacteria.

The degradation of the polysulfides is greatly accelerated by neutralization of a polysulfide solution with dilute acids, preferably sulfuric acid, because not only the sulfides Me₂S but also sulfur is immediately liberated according to

Me₂S_{z}+acid - - - >Me₂S+(z−1)S.

The liberated sulfur is, as far as known, environmentally neutral.

### EXAMPLES

### General Procedure

The synthesis according to the invention of the polysulfides was carried out using small amounts in test tubes in order to demonstrate its simplicity.

For this purpose. commercial sodium hydrogensulfide in a concentration of 76% by weight (balance: water) and sulfur in commercial purity were used.

Potassium hydrogensulfide was prepared by passing hydrogen sulfide into 112 gram of a commercial 50% strength by weight aqueous potassium hydroxide solution, corresponding to one mole, while cooling until the solution was saturated. A temperature of 50° C. was not exceeded during this reaction. The mass of the solution increased by 34 gram, corresponding to one mole of hydrogen sulfide. This gave an aqueous solution of potassium hydrogensulfide in a concentration of 49 percent by weight.

After weighing out the alkali metal hydrogensulfide and the sulfur, the atmospheric oxygen was displaced by argon and the mixture was heated under a blanket of argon from room temperature to from 100 to 130° C. The sulfur melted and the reaction to form polysulfide commenced at the same time. The temperature increased adiabatically within a few seconds to values of 130° C.-150° C. Water mixed with hydrogen sulfide distilled off.

After a short time, the temperature was increased further to values of about 500° C. over a period of from 2 to 5 minutes in order to vaporize the water as completely as possible.

The temperature of the reaction product was subsequently maintained for about 2 minutes more. The temperatures were measured electronically by means of a thermocouple. The lower use temperature measured during cooling was reported as that temperature at which the melt just began to draw thin threads when the thermocouple having a diameter of 1.5 millimeters was taken out of the melt. The corresponding viscosity was about 200 cP.

### Example I

2NaHS+1.8S - - - >Na₂S_{2.8}+H₂S

0.04 mol of sodium hydrogensulfide (2.95 gram, 76 percent strength by weight) and 0.036 mol (1.15 gram) of sulfur were weighed into a test tube and reacted according to the procedure described. The resulting red liquid having the composition Na₂S_{2.8} was fluid. On cooling, it began to draw threads at 140° C. On cooling further, it solidified with crystallization.

The liquid was heated to 700° C. in the test tube. The color changed to black and few gas bubbles were formed at the beginning. As far as the eye could discern, no sulfur was liberated. On cooling, the red color returned and the properties had not changed.

An analogously prepared sodium polysulfide having the composition NaS₃ had a somewhat higher viscosity. It began to drawn threads at 150° C. during cooling and on further cooling solidified without crystallization to form a vitreous solid.

The sodium polysulfide Na₂S₃ was prepared once more, but, in contrast to the first procedure, by dewatering sodium hydrogensulfide in one step by heating to about 350° C. In the second step. the sulfur was added and the mixture was heated while shaking. The polysulfide obtained in this way began to draw threads at 135° C. during cooling.

### Example 2

2KHS+2.4S - - - >K₂S_{3.4}+H₂S

In a manner analogous to example 1, 0.04 mol of potassium hydrogensulfide (5.88 gram, 49 percent strength by weight) was reacted with 0.048 mol (1.54 gram) of sulfur.

On cooling, the red liquid having the composition K₂S_{3.4} began to draw threads at 150° C. It crystallized on further cooling. On heating to about 750° C., it became dark. Signs of decomposition were not observed. When cooled, it became red again and began to draw threads at 150° C., which shows that it experienced no change on heating to 750° C.

### Example 3

KHS+NaHS+1.7S - - - >(K_{0.5}Na_{0.5})₂S_{2.7}+H₂S

0.02 mol of sodium hydrogensulfide, 0.02 mol of potassium hydrogensulfide and 0.034 mol of sulfur were reacted with one another in a manner analogous to example 1. This gave a red low-viscosity liquid having the composition (K_{0.5}Na_{0.5})₂S_{2.7} which on cooling drew threads at 125° C. and crystallized on further cooling. The liquid was heated to 700° C., resulting in it becoming dark. After cooling, it once again had the properties as before heating.

### Example 4

1.5KHS+0.5NaHS+2.2S - - - >(K_{0.75}Na_{0.25})₂S_{3.2}+0.5H₂S

Using a method analogous to example 1, 0.06 mol of potassium hydrogensulfide, 0.02 mol of sodium hydrogensulfide and 0.088 mol of sulfur were reacted with one another and dewatered. This gave a red liquid having the composition (K_{0.75}Na_{0.25})₂S_{3.2} which on cooling began to draw threads at 125° C. and solidified to form a vitreous solid on further cooling. The liquid was heated to 700° C. and then allowed to cool again. After cooling, it began to draw threads at 125° C.

### Example 5

0.04KHS+0.032NaOH+0.088S - - - >0.036(K_{0.555}N_{0.4-4.45})₂S_{3.2}+0.032 H₂O+0.004H₂S

0.032 mol (1.28 gram) of 100% strength sodium hydroxide was dissolved while heating in 0.04 mol of 49% strength potassium hydrogensulfide solution (5.88 gram), corresponding to 80% of the molar amount of sodium hydroxide necessary to convert the potassium hydrogensulfide completely into sulfide. 0.088 mol of sulfur (2.82 gram) was weighed into the homogeneous solution and the reaction mixture was, after the exothermic reaction had abated and water and hydrogen sulfide had distilled off, heated to about 600° C. The red liquid began to draw threads at 135° C. during cooling. When the temperature was lowered further, the liquid solidified to form a vitreous solid.

In a further experiment, the polysulfide having the above composition was prepared again but this time by dewatering the reaction mixture of the potassium hydrogensulfide and the sodium hydroxide. In the second step, the dewatered hydrogensulfide/sulfide mixture was reacted with sulfur. The resulting red polysulfide began to draw threads at 115° C. during cooling, and on further cooling it solidified to form a vitreous solid.

### Example 6

0.04KHS+0.024KOH+0.0544S - - - >0.032K₂S_{2.7}+0.024H₂O+0.008H₂S

Using a method analogous to example 4, 0.024 mol (1.66 gram) of 81% strength potassium hydroxide was dissolved in 0.04 mol of 49% strength potassium hydrogensulfide while heating.

The amount of potassium hydroxide corresponded to 60% of the theoretical amount of potassium hydroxide for complete neutralization of the hydrogen sulfide. 0.0544 mol (1.74 gram) of sulfur was weighed into this solution and the reaction mixture was, after the exothermic reaction had occurred with water and hydrogen sulfide being distilled off, heated to about 600° C.

On cooling, the red liquid began to crystallize at 190° C.

The following relationships were derived from a number of experiments:

Increasing potassium contents promote crystallization. The melt viscosity is increased by increasing sulfur contents to a greater degree than in the case of a higher sodium content.

The thermal stability is promoted by very small sulfur contents.

According to the literature, the corrosivity of the alkali metal polysulfides is reduced by low sulfur contents, as indicated above.

The optimal composition is thus a composition having the highest possible sodium content at the lowest possible sulfur content. However, a proportion of potassium is required in order to suppress crystallization, and this is all the more important the lower the sulfur content.

Optimal compositions are in the range

(Na_{0.5-0.65}K_{0.5-0.35})₂S_{2.4-2.8}

One of these alkali metal polysulfides having the composition

(Na_{0.6}K_{0.4})₂S_{2.6}

does not decompose at temperatures up to 700° C. and on cooling continuously has a low viscosity and does not draw threads down to about 110-115° C., its melting range.

According to the calculated Na₂S—K₂S—S phase diagram in the cited literature (Lindberg et. al), this composition should have a melting range of about 360-380° C.

1. A composition for the transport and storage of heat energy, which comprises alkali metal polysulfides of the formula (Me1₍₁₋ₓ₎Me2ₓ)₂S_{z}, where Me1 and Me2 are selected from the group of alkali metals consisting of lithium, sodium, potassium, rubidium and cesium, Me1 is different from Me2 and x is from 0 to 1 and z is from 2.3 to 3.5.

2. The composition according to claim 1, wherein Me1 is potassium and Me2 is sodium.

3. The composition according to claim 1, wherein x is from 0.5 to 0.7 and z is from 2.4 to 2.9.

4. The composition according to claim 1 having the formula (Na_{0.5-0.65}K_{0.5-0.35})₂S_{2.4-2.8} or (Na_{0.6}K_{0.4})₂S_{2.6}.

5. The composition according to claim 1, wherein the alkali metal polysulfides can he obtained by reacting concentrated aqueous solutions of alkali metal hydrogensulfides with sulfur.

6. The composition according to claim 1, wherein the alkali metal polysulfides can be obtained by reacting alkali metal hydrogensullides with a molar excess of alkali metal hydroxides to form alkali metal sulfides mixed with alkali metal hydrogensulfides and reacting these with sulfur to convert them completely into alkali metal polysulfides and, optionally under reduced pressure, distilling off the water at temperatures up to 500° C.

7. The composition according to claim 1, wherein the alkali metal polysul tides are prepared by dewatering aqueous solutions of alkali metal hydrogensulfides or aqueous solutions of alkali metal hydrogensulfides which have been reacted with a molar excess of alkali metal hydroxides to form alkali metal sulfides mixed with alkali metal hydrogensulfides, optionally under reduced pressure, and, in a second step, reacting the dewatered alkali metal hydrogensulfides/alkali metal sulfides with liquid sulfur to form the alkali metal polysulfides.

8. The composition according to claim 6, wherein a maximum of 0.9 mol of alkali metal hydroxide is used per mole of alkali metal hydrogensulfide.

9. The use of the composition as defined in claim 1 in the presence of aluminum-comprising materials.

10. The use of the composition as defined in claim 1 in the presence of iron-based materials.

11. The use according to claim 10, wherein the iron-based materials comprise from 6 to 28 percent by weight of aluminum and less than 3 percent by weight of molybdenum and up to 2 percent by weight of each of zirconium and/or yttrium.

12. The use of the composition as defined in claim 1 as medium for the transport and/or storage of heat energy.

13. The use of the composition as defined in claim 1 for the transport and/or storage of heat energy in solar thermal power stations or in the primary circuit of nuclear power stations.

14. The use of the composition as defined in claim 1 as heat transfer fluid, wherein the heat energy thereof is transferred to another medium as heat storage.

15. The use according to claim 14, wherein the other medium is sulfane-comprising low-viscosity sulfur.

16. A plant for generating energy, which comprises a composition as defined in claim 1.

17. The plant according to claim 16, which compriseS a composition as defined in any of claims 1 to 8 as heat transfer medium and/or heat storage medium.

18. The composition according to claim 1 wherein x is from 0.5 to 0.7 and z is from 2.4 to 2.9.

19. The composition according to claim 2 having the formula (Na_{0.5-0.65}K_{0.5-0.35})₂S_{2.4-2.8} or (Na_{0.6}K_{0.4})₂S_{2.6}.

20. The composition according to claim 3 having the formula (Na_{0.5-0.65}K_{0.5-4.35})₂S_{2.4-2.8} or (Na_{0.6}K_{0.4})₂S_{2.6}.
